(19) United States
(12) Patent Application Publication
(10) Pub. No.: US 2011/0045689 A1
(43) Pub. Date: Feb. 24, 2011

(54) POWER SUPPLY DEVICE WITH A POWER OUTPUT ASSEMBLY

(76) Inventor: Tsung-Yen Tsai, Taipei Hsien (TW)

Correspondence Address: Tsung-Yen Tsai, 235 Chung - Ho Box 8-24 Taipei, Taiwan, R. O. C., Taipei, 235, TW

(21) Appl. No.: 12/545,855

(22) Filed: Aug. 23, 2009

(51) Int. Cl. H01R 13/717

(52) U.S. Cl. 439/490

(57) ABSTRACT

A power supply device with a power output assembly for computers and other peripherals comprises a power supply having a circuit board and a casing plate; the casing plate being formed with at least one assembly hole; a first output module and a second output module installed to the power supply; the second output module including a substrate, at least one slot and at least one conductive wire; the second output module passing through the assembly hole of the casing plate; the second output module being made of transparent material and being positioned on the substrate; and at least one light-emitting element installed on the substrate and aside the second output module. When the second output module is combined to the substrate, light from the light-emitting element passing through the second output module and emitting out from the joint of the conductive wire.

### FIELD OF THE INVENTION

The present invention relates to power supplies, in particular to a power supply which can display the insertion state through light-emitting elements so that the user can assure the power supplying state of the power supply and convenient and safe operation of the power supply is achieved. Furthermore, the present invention provides the power supply with a beautiful outlook.

### BACKGROUND OF THE INVENTION

Other than providing stable and safe power supply, the computer power supply further also provides the function of convenient insertion and multiple power outputs for satisfying customer's requirement.

In U.S. Pat. No. 7,187,544 assigned to the inventor of the present invention, referring to FIG. 1, a power output device of a power supply is illustrated. The power supply 91 has an output end for supplying external power. Voltage of the input power is decreased as the current passes through a circuit board 91. Next, the current is rectified and then is supplied to a computer through an output device. The feature of the patent is that the output device includes a main cable 92, a sub-cable 93 and an external connection module 94. The main cable 92 and the sub-cable 93 are connected to the power output bank of the circuit board 91 of the power supply 90. A power output end of the main cable 92 has a plug and the power output end of the sub-cable 93 has another plug. The external connection module 94 is formed by a substrate 941, a plurality of slot assembly 942 and at least one conductive wire 943. The substrate 941 has a printed circuit board and is connected to the power output bank of the circuit board 91 for receiving power. The slot assembly 942 is positioned on the substrate 941 and are positioned in the through holes of the back plate 901 of the power supply 90. The slot assembly 942 are electrically connected to the printed circuit board so that each slot assembly 942 has independent power output. One end of the conductive wire 943 is a joint which is inserted to the slot assembly 942 and another end thereof is a plug for receiving power.

The above mentioned patent provides the function of free insertion and convenient operation. Furthermore, it is also beneficial to the manufacturers, the external connection module 94 causes that the power supply can be made easily with less labor and lower cost, while the yield is promoted.

However the inventor of the invention discovers that some apparent features can be added to the prior art power supply for further promoting the overall effect of the power supply, for example, the power supply state (such as in normal state or is be damaged) of each power output end of the power supply can not be displayed for viewing directly. Furthermore, when the power supply is installed in the computer casing, it cannot be viewed from the net holes or windows of the casing so that it must be detected by using meters. However these induce some inconveniences to users.

### SUMMARY OF THE INVENTION

Accordingly, the main object of the present invention is to provide a computer power supply assembly with a power output device which includes an easily-installed simple structure, when the power is outputted from the power supply assembly, a light-emitting element will emit light so that the user can detect the power output easily and the power supply may present a beautiful outlook.

To achieve above object, the present invention provides a power supply device with a power output assembly for computers and other peripherals, the power supply device comprising: a power supply having a circuit board and a casing plate; the casing plate being formed with at least one assembly hole; a first output module installed to the power supply; a second output module installed to the power supply; the second output module including a substrate, at least one slot and at least one conductive wire; the substrate being formed with a printed circuit board which is electrically connected to a power output bank wires of the circuit board within the power supply for power supplying; the second output module passing through the assembly hole of the casing plate; the second output module being made of transparent material and being positioned on the substrate; a terminal in the slot being electrically connected to the substrate so that the slot outputs power independently; and at least one light-emitting element installed on the substrate and aside the second output module; when the second output module being combined to the substrate, the light-emitting element being exactly received in the receiving portion; light from the light-emitting element passing through the light guide surface of the second output module and emitting out from the joint of the conductive wire.

By the present invention, when the joint of the conductive wire of the light-emitting element is connected to the slot and power is turned on, light from the light-emitting element will transmit through the second output module so that the user can view the state of the power supply and thus the convenience and safety about the use of the power supply is promoted.

The various objects and advantages of the present invention will be more readily understood from the following detailed description when read in conjunction with the appended drawing.

### BRIEF DESCRIPTION OF THE DRAWINGS

FIG. 1 is a perspective view about the device illustrated in U.S. Pat. No. 7,187,544.

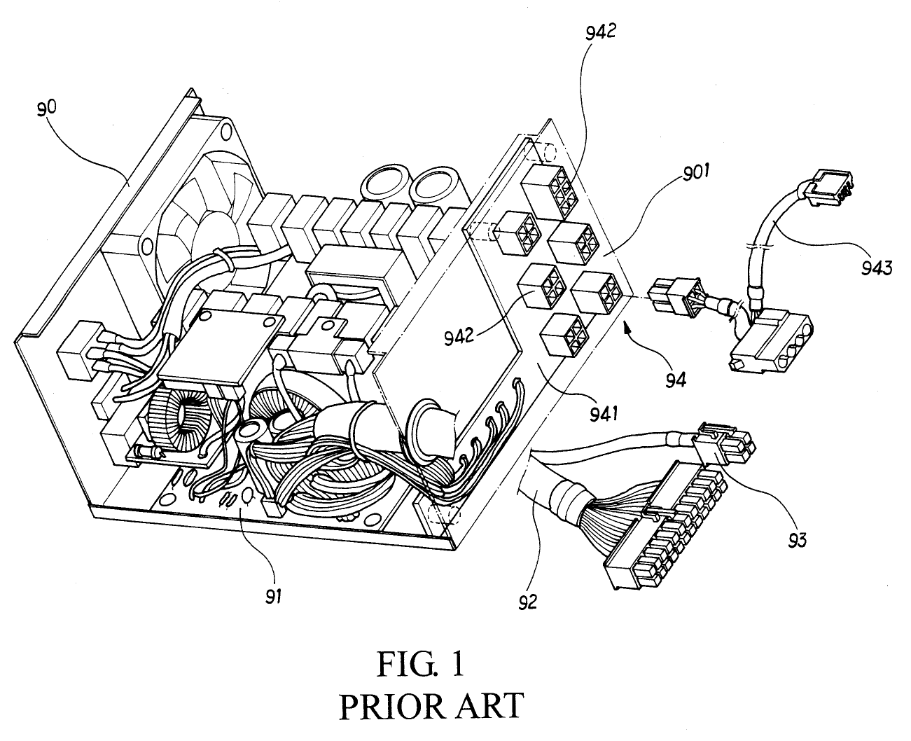

FIG. 2 is an assembled perspective view of the present invention.

FIG. 3 is a schematic view showing the insertion of the present invention.

FIG. 4 is a schematic view showing the connection of a joint to the slot assembly according to the present invention.

FIG. 5 is a schematic view showing a light guiding state as the power is outputted.

FIG. 6 is a schematic view showing that the light from the light-emitting element transmits through the slot assembly and joint according to the present invention.

FIG. 7 is an assembled schematic view showing another embodiment of the present invention.

FIG. 8 is a schematic view showing the light guiding state when power is outputted.

FIG. 9 is a schematic view showing a further embodiment of the present invention, where the insertion state of the present invention is illustrated.

FIG. 10 shows that the light from the light-emitting element transmits through the slot and joint according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

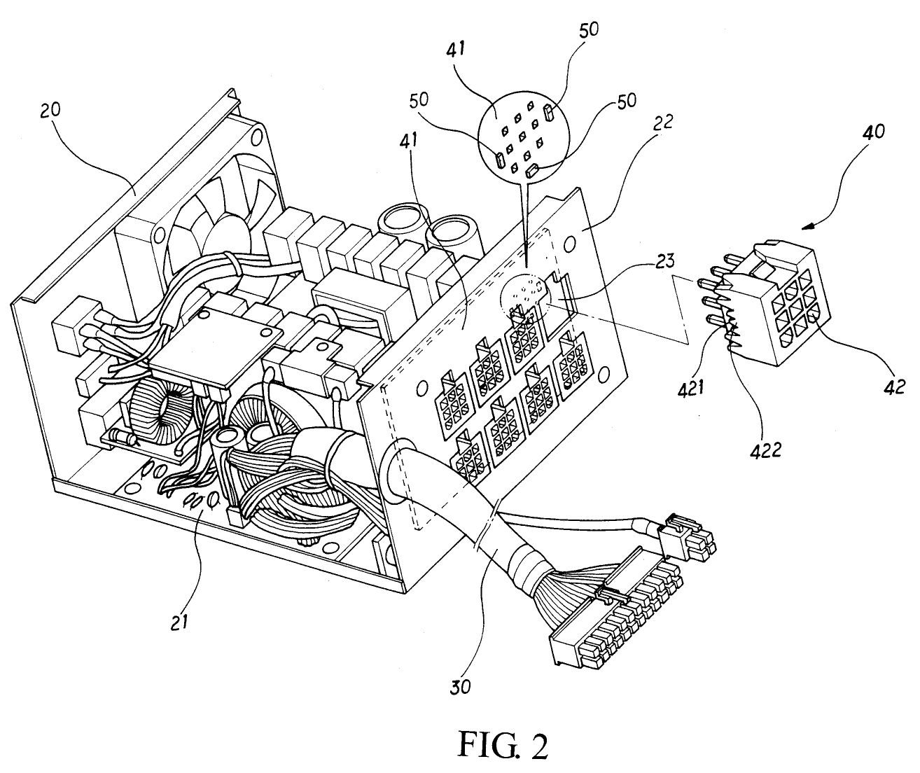

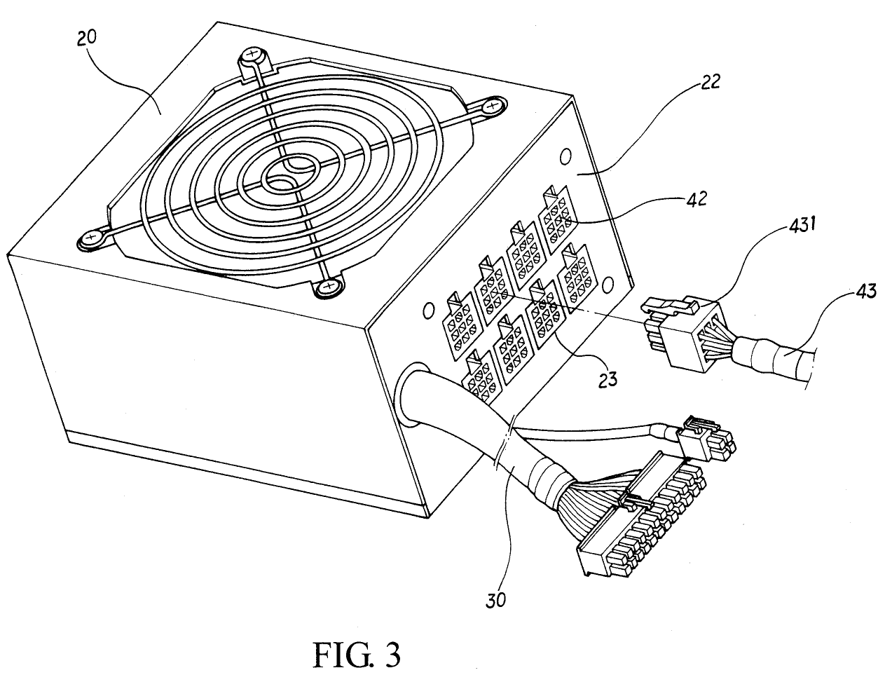

With reference to FIGS. 2 to 4, a computer power supply assembly with a power output device according to the present invention is illustrated. The present invention is applied to the power connection and supply for computer devices and the peripherals thereof. The computer power supply assembly includes the following elements.

A power supply 20 has a circuit board 21 and a casing plate 22. The casing plate 22 is formed with at least one assembly hole 23.

A first output module 30 is installed to the power supply 20 and is a cable having a joint (not shown).

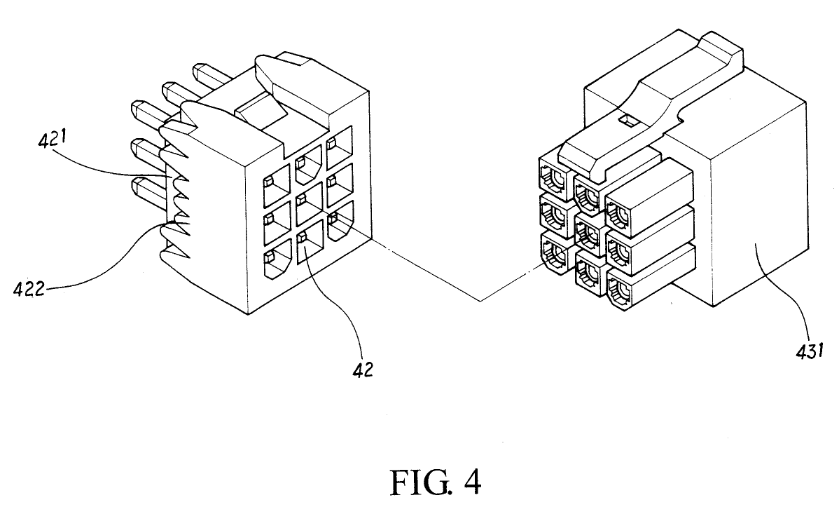

A second output module 40 is installed to the power supply 20. The second output module 40 includes a substrate 41, at least one slot 42 and at least one conductive wire 43. The substrate 41 is formed with a printed circuit board which is electrically connected to a power output bank wires of the circuit board 21 within the power supply 20 for supplying power. The second output module 40 passes through the assembly hole 23 of the casing plate 22. The second output module 40 is made of transparent material and is positioned on the substrate 41. A terminal end of the slot 42 is electrically connected to the substrate 41 so that the slot 42 may output power independently. One end of the conductive wire 43 has a joint 431. The joint 431 is made of transparent material. A backside of the second output module 40 is formed with one recessed receiving portion 421 (as shown in FIG. 4).

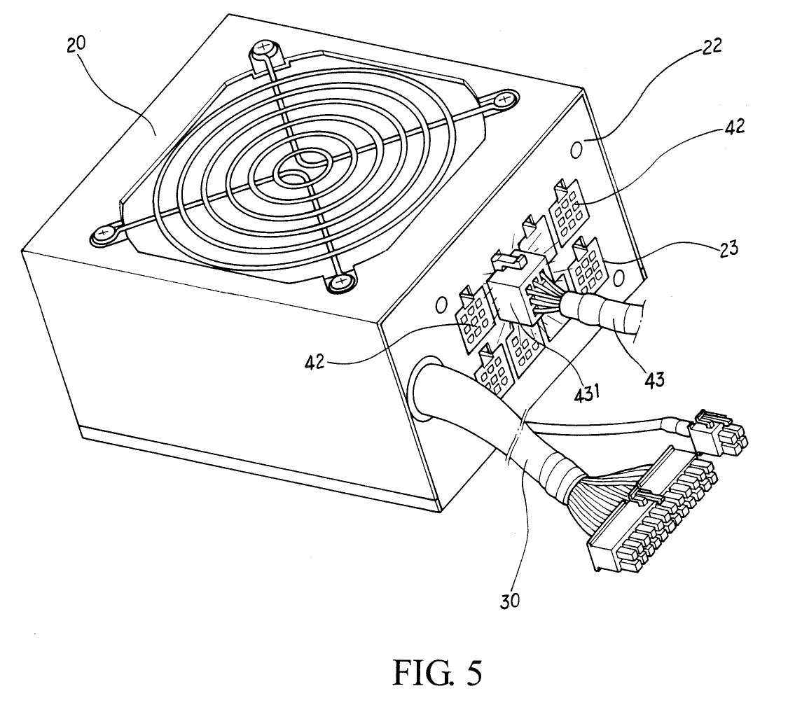

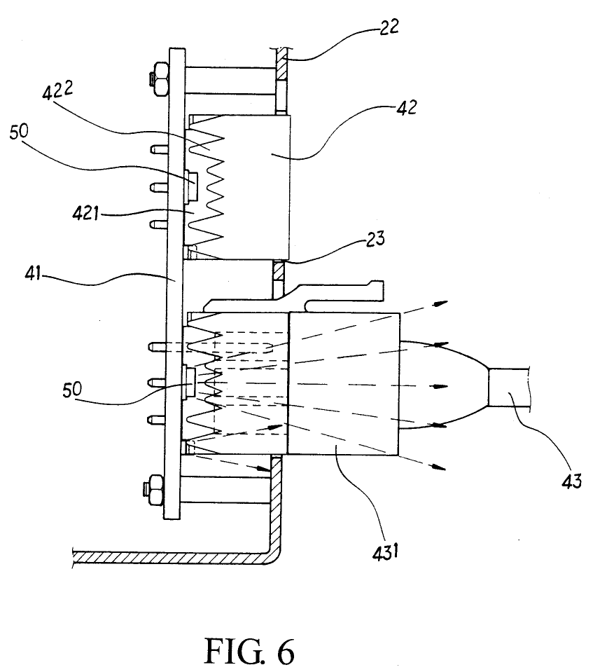

At least one light-emitting element 50 is installed on the substrate 41 and aside the slot 42. Preferably, the light-emitting element 50 is an LED (light-emitting diode). When second output module 40 is combined to the substrate 41, the light-emitting element 50 is exactly received in the receiving portion 421 of the second output module 40. The receiving portion 421 has a light guide surface 422 for transmitting light from the light-emitting element 50. Preferably, the light guide surface 422 is, as illustrated in the drawing, a teethed surface or a curved surface. The light from the light-emitting element 50 passes through the light guide surface 422 of the slot assembly 42 and emits out from the joint 431 of the conductive wire 43 (as shown in FIGS. 5 and 6) so that the user can view the light and moreover, the power supply 20 can present a beautiful outlook.

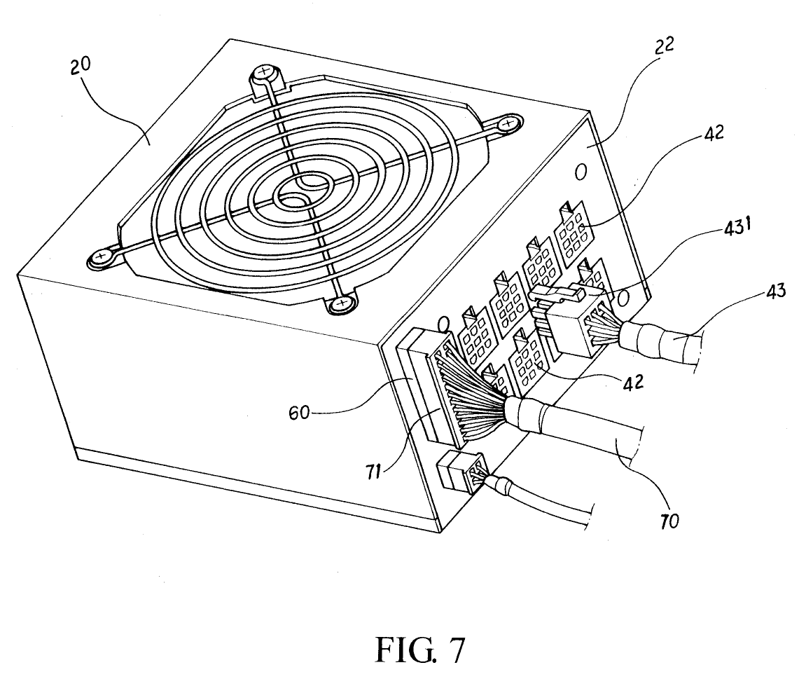

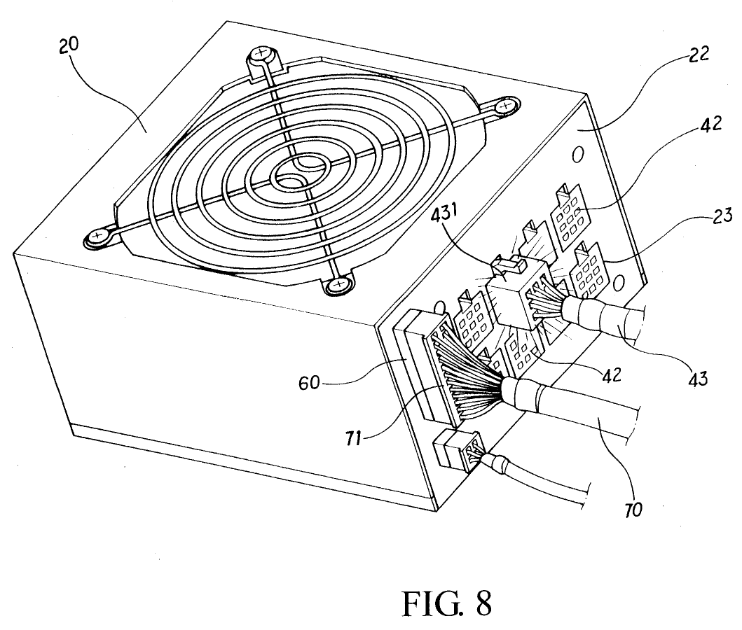

With reference to FIGS. 7 to 8, another embodiment of the present invention is illustrated. This embodiment is similar to above mentioned embodiment, and thus in the following, only those differences therebetween are described. In this embodiment, the first output module 30 is similar to the above mentioned second output module 40. The second output module 40 is installed to the casing plate 22 of the power supply 20 through a power connecting seat 60 with a plurality of pins and is electrically connected to the power output bank of the circuit board 21. Further, a power wire 70 has a plug 71 at one end thereof. The plug 71 of the power wire 70 is connected to the power connecting seat 60. Another end of the power wire 70 is connected to a computer or other peripherals.

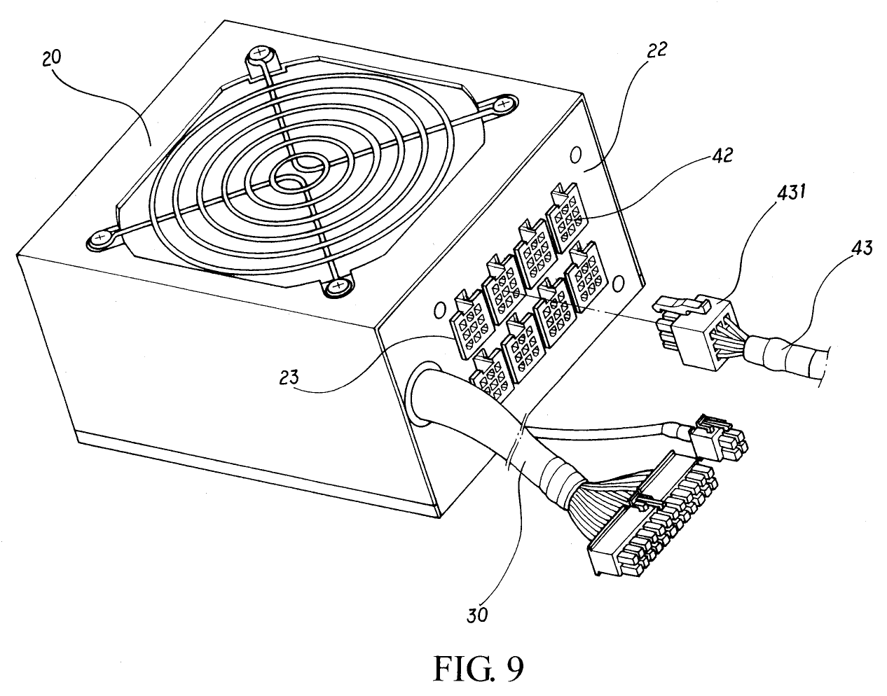

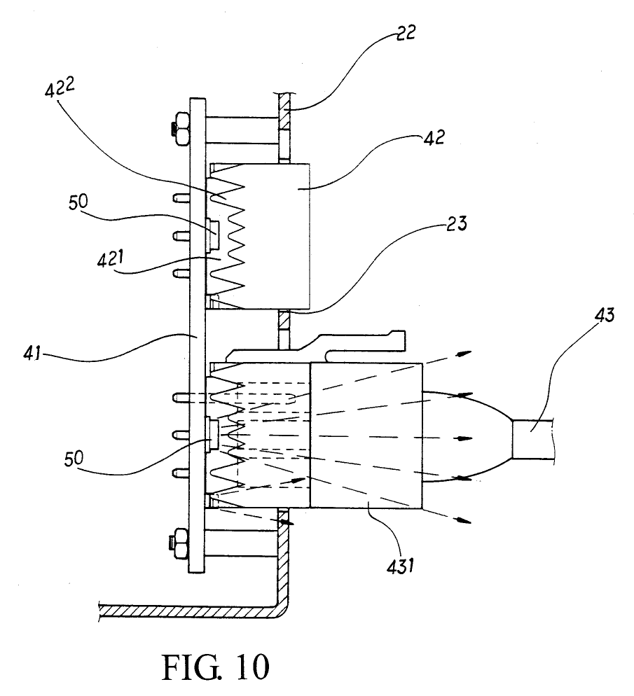

With reference to FIGS. 9 to 10, a further embodiment of the present invention is illustrated. This embodiment is identical to the former one. The casing plate 22 of the power supply 20 is installed with at least one assembly hole 23. The first output module 30 is a cable with a plug. The second output module 40 has at least one slot 42 and protrudes out from the casing plate 22 with a predetermined height for receiving the conductive wire 43 of the plug 431. The light-emitting element 50 is installed in the receiving portion 421. Light from the light-emitting element 50 transmits out of the light guide surface 422. By above-mentioned structure, the second output module 40 protrudes from the casing plate with a predetermined height. Other than being inserted easily, light from the light-emitting element 50 is more apparent to viewers.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A power supply device with a power output assembly for computers and other peripherals, comprising:
a power supply having a circuit board and a casing plate; the casing plate being formed with at least one assembly hole;
a first output module installed to the power supply;
a second output module installed to the power supply; the second output module including a substrate, at least one slot and at least one conductive wire; the substrate being formed with a printed circuit board which is electrically connected to a power output bank wires of the circuit board within the power supply for power supplying; the second output module passing through the assembly hole of the casing plate; the second output module being made of transparent material and being positioned on the substrate; a terminal in the slot being electrically connected to the substrate so that the slot outputs power independently; and
at least one light-emitting element installed on the substrate and aside the second output module; when the second output module being combined to the substrate, the light-emitting element being exactly received in the receiving portion; light from the light-emitting element passing through the second output module and emitting out from the joint of the conductive wire.

2. The power supply device with a power output assembly as claimed in claim 1, wherein the second output module is made of transparent material.

3. The power supply device with a power output assembly as claimed in claim 1, wherein the second output module is formed with a receiving portion for receiving the light-emitting element.

4. The power supply device with a power output assembly as claimed in claim 1, wherein a backside of the second output module is formed with one recessed receiving portion for receiving the light-emitting element; the receiving portion has a light guide surface for transmitting light from the light-emitting element.

5. The power supply device with a power output assembly as claimed in claim 4, wherein the light guide surface is a teethed surface or a curved surface.

6. The power supply device with a power output assembly as claimed in claim 1, wherein a lateral side of the second output module is formed with one receiving portion for receiving the light-emitting element and the receiving portion is recessed at one surface of a lateral wall of the second output module.

7. The power supply device with a power output assembly as claimed in claim 1, wherein one end of the conductive wire has a joint which can be connected to the slot and the joint is made of transparent material.

8. The power supply device with a power output assembly as claimed in claim 1, wherein the first output module is a cable having a joint.

9. The power supply device with a power output assembly as claimed in claim 1, wherein the first output module further includes:
a power receptacle installed to the casing plate of the power supply; and a power connection wire having one end corresponding to the plug of the power receptacle and another end installed with a power plug.

10. The power supply device with a power output assembly as claimed in claim 1, wherein the light-emitting element is a light-emitting diode.
